(19) United States
(12) Patent Application Publication
(10) Pub. No.: US 2008/0174242 A1
(43) Pub. Date: Jul. 24, 2008

(54) Plasma display panel

(76) Inventors: Hyun Soh, Suwon-si (KR); Jin-Won Han, Suwon-si (KR); Joong-Ho Moon, Suwon-si (KR)

Correspondence Address: ROBERT E. BUSHNELL, 1522 K STREET NW, SUITE 300, WASHINGTON, DC, 20005-1202, US

(21) Appl. No.: 11/898,764

(22) Filed: Sep. 14, 2007

(30) Foreign Application Priority Data
Jan. 24, 2007 (KR) 10-2007-0007640

(51) Int. Cl. H01J 17/49

(52) U.S. Cl. 313/582

(57) ABSTRACT

A plasma display panel includes a plurality of substrates facing each other, a plurality of discharge electrodes disposed between the substrates, a barrier rib structure disposed between the substrates to define a plurality of discharge cells, and a plurality of phosphor layers coated in the discharge cells, wherein each of the discharge cells is divided into at least two discharge spaces by auxiliary barrier ribs, thereby increasing areas of the phosphor layers coated in the discharge cells. And a plurality of electric field concentration portions are formed between X electrodes and Y electrodes in the divided discharge spaces, thereby increasing light emission efficiency.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on 24 Jan. 2007 and there duly assigned Serial No. 2007-007640.

### BACKGROUND OF THE INVENTION

1. Field of the Invention

The present invention relates to a plasma display panel, and more particularly, to a plasma display panel having increased discharge efficiency and discharge characteristics due to a structure in which a unit discharge cell is divided into a plurality of discharge spaces.

2. Description of the Related Art

A PDP is a flat panel display device that displays desired numbers, letters, or graphics using visible light emitted from phosphor layers which are excited by ultraviolet rays generated during a gas discharge which is generated by applying a direct or alternate current voltage applied to a plurality of electrodes formed on a plurality of substrates after a discharge gas is sealed between the plurality of substrates.

Generally, plasma display panels (PDPs) can be classified into direct current (DC) PDPs and alternating current (AC) PDPs according to the type of driving voltage applied to discharge cells, i.e., according to discharge type. PDPs can further be classified into facing discharge PDPs and surface discharge PDPs according to the arrangement of electrodes.

Recently, researches have been conducted on panel structures that can increase light emission efficiency by increasing the areas where a phosphor layer is coated or modifying the structure of an electric field concentration part.

### SUMMARY OF THE INVENTION

To solve the above and/or other problems, the present invention provides a plasma display panel having increased light emission efficiency by separating a unit discharge cell into a plurality of discharge spaces, forming a plurality of electric field concentration portions in the unit discharge cell, and increasing coating areas of phosphor layers.

According to an aspect of the present invention, there is provided a plasma display panel comprising: a plurality of substrates facing each other; a plurality of discharge electrodes disposed between the substrates; a barrier rib structure disposed between the substrates to define a plurality of discharge cells; and a plurality of phosphor layers coated in the discharge cells, wherein one discharge space of each of the discharge cells is divided into at least two discharge spaces.

The divided discharge spaces of each of the discharge cells may be defined by an auxiliary barrier rib disposed in the discharge cell.

The auxiliary barrier rib may extend from a pair of adjacently disposed barrier ribs towards each other to divide one discharge cell into multiple discharge spaces.

The discharge electrodes may comprise sustain discharge electrode pairs having X electrodes and Y electrodes and address electrodes disposed in a direction crossing the sustain discharge electrodes, wherein the X electrodes are disposed above the barrier rib structure that defines adjacent discharge cells.

The Y electrodes may be disposed above the auxiliary barrier ribs.

One discharge space may comprise the plurality of X electrodes disposed above the barrier rib pair, one Y electrode disposed above the auxiliary barrier rib, and one address electrode.

Gaps may be formed between upper surfaces of the auxiliary barrier ribs and an inner surface of the substrate to exhaust a discharge gas when the discharge spaces are vacuumed.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of a three-electrode surface discharge type plasma display panel;

FIG. 2 is a partial cut-away perspective view of a plasma display panel according to an embodiment of the present invention;

FIG. 3 is a plan view of the plasma display panel of FIG. 2, according to an embodiment of the present invention;

FIG. 4 is a cross-sectional view taken along line I-I of the assembled plasma display panel of FIG. 2, according to an embodiment of the present invention; and

FIG. 5 is a cross-sectional view of an assembled plasma display panel according to another embodiment of the present invention.

### DETAILED DESCRIPTION OF THE INVENTION

The present invention will now be described more fully with reference to the accompanying drawings in which exemplary embodiments of the invention are shown.

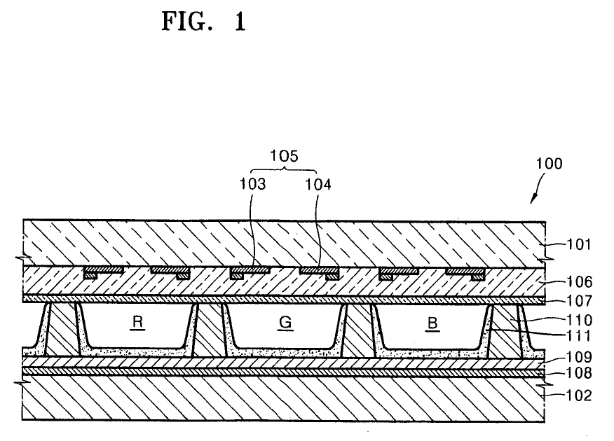

FIG. 1 is a cross-sectional view illustrating a three-electrode surface discharge type plasma display panel 100. The three-electrode surface discharge type plasma display panel 100 includes a first substrate 101, a second substrate 102, sustain discharge electrode pairs 105 each having an X electrode 103 and a Y electrode 104 formed on an inner surface of the first substrate 101, a first dielectric layer 106 that buries the sustain discharge electrode pairs 105, a protective film layer 107 formed on a surface of the first dielectric layer 106, a plurality of address electrodes 108 formed on an inner surface of the second substrate 102 in a direction crossing the sustain discharge electrode pairs 105, a second dielectric layer 109 that buries the address electrodes 108, a barrier rib structure 110 formed between the first and second substrate 101 and 102 to define a plurality of discharge cells, and red, green, and blue phosphor layers 111 formed in the barrier rib structure 110.

In the three-electrode surface discharge type plasma display panel 100 having the above structure, when an electric signal is applied to the address electrodes 108 and the Y electrode 104, discharge cells for emitting light are selected, and electric signals are alternately applied to the X electrode 103 and the Y electrode 104, visible light is emitted from phosphor materials of the phosphor layers 111 coated on the selected discharge cells, and thus, a stationary or moving image can be displayed.

In the three-electrode surface discharge type plasma display panel 100, a discharge in the discharge cells is generated by controlling a voltage applied to the X electrode 103, the Y electrode 104, and the address electrodes 108, and as a result of the discharge, visible light is emitted. Also, in a unit discharge cell of the above structure, a single electric field is formed.

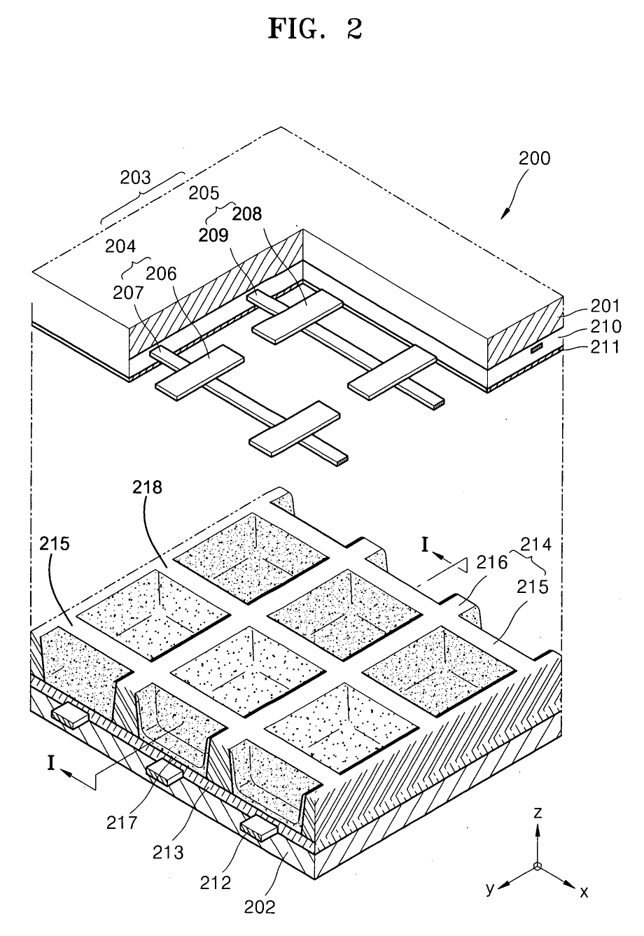

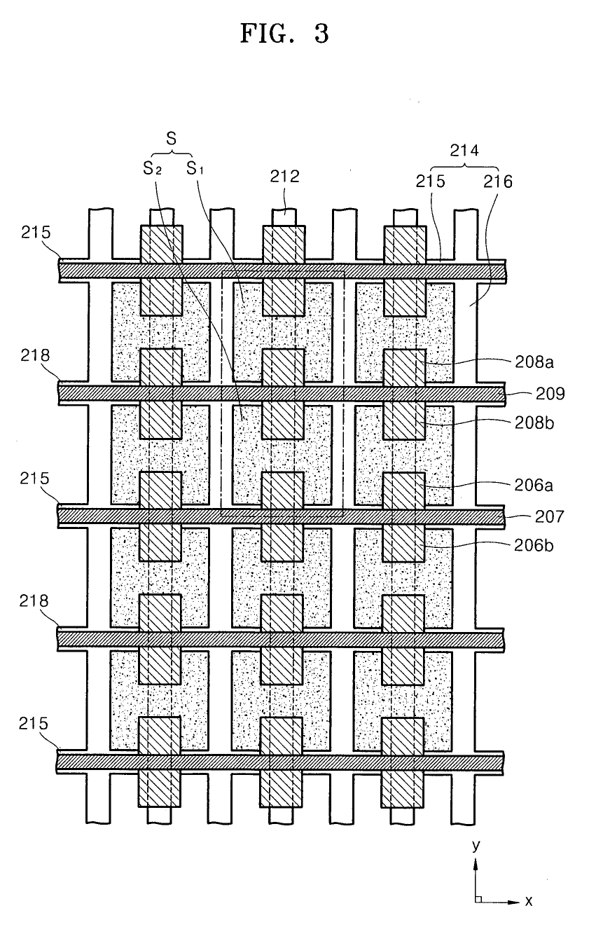

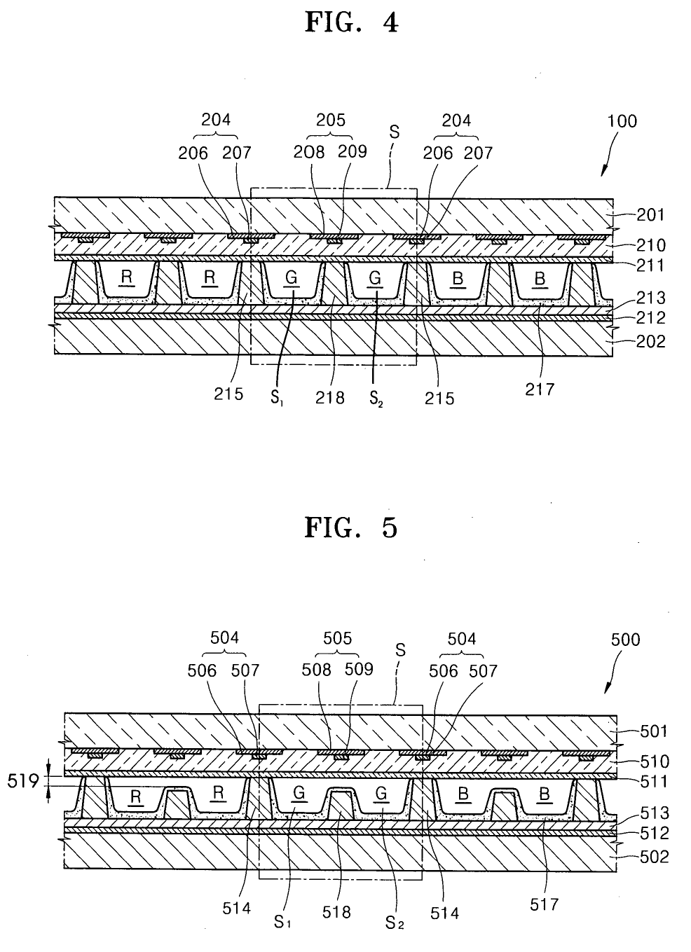

FIG. 2 is a partial cut-away perspective view of a plasma display panel 200 according to an embodiment of the present invention. FIG. 3 is a plan view of the plasma display panel 200 of FIG. 2, and FIG. 4 is a cross-sectional view taken along line I-I of the assembled plasma display panel 200 of FIG. 2, according to an embodiment of the present invention.

Referring to FIGS. 2 through 4, the plasma display panel 200 includes a first substrate 201 and a second substrate 202 facing the first substrate 201. Glass frit (not shown) is coated along edges of inner surfaces of the first substrate 201 and the second substrate 202 to seal discharge cells.

The first substrate 201 is a transparent substrate formed of, for example, soda lime glass. Alternatively, the first substrate 201 can be a semi-transparent substrate, a colored substrate, or a reflection plate.

X electrodes 204 and Y electrodes 205, which form sustain discharge electrode pairs 203, are disposed on an inner surface of the first substrate 201 along an X direction of the plasma display panel 200. Each of the X electrodes 204 includes an X transparent electrode 206 and an X bus electrode 207 stacked on the X transparent electrode 206. Each of the Y electrodes 205 includes a Y transparent electrode 208 and a Y bus electrode 209 stacked on the Y transparent electrode 208.

The X electrodes 204 and the Y electrodes 205 are buried by a first dielectric layer 210. The first dielectric layer 210 can be formed of a high dielectric material, for example, ZnO—B₂O₃—Bi₂O₃. The first dielectric layer 210 can be selectively formed on regions where the X electrodes 204 and the Y electrodes 205 are formed, or can be formed on all areas of an inner surface of the first substrate 201.

A protective film layer 211 is deposited on a surface of the first dielectric layer 210 using, for example, MgO in order to prevent the first dielectric layer 210 from being damaged and to increase the emission of secondary electrons.

The second substrate 202 can be formed of substantially the same material used to form the first substrate 201. A plurality of address electrodes 212 are disposed on an inner surface of the second substrate 202 in a direction crossing the sustain discharge electrode pairs 203. The address electrodes 212 are buried in a second dielectric layer 213. The second dielectric layer 213 is formed of a high dielectric material, for example, PbO—B₂O₃—SiO₂. A barrier rib structure 214 that defines a plurality of discharge spaces (cells) together with the first substrate 201 and the second substrate 202 is formed between the first and second substrates 201 and 202.

The discharge cells defined by the combination of the first substrate 201, the second substrate 202, and the barrier rib structure 214 are filled with a discharge gas such as Ne—Xe gas or He—Xe gas.

Also, red, green, and blue phosphor layers 217 for emitting visible light by being excited by ultraviolet rays generated from the discharge gas are formed in the discharge cells. The phosphor layers 217 can be coated in any region in the discharge cells.

Furthermore, the phosphor layers 217 comprise red, green, and blue phosphor materials, but are not limited thereto. That is, the phosphor layers 217 can be replaced by different color phosphor layers, or an additional different phosphor layer can be added. In the present embodiment, the red phosphor layer may be formed of (Y,Gd)BO₃;Eu⁺³, the green phosphor layer may be formed of Zn₂SiO₄:Mn²⁺, and the blue phosphor layer may be formed of BaMgAl₁₀O₁₇:Eu²⁺.

The discharge cell defined by the combination of the first substrate 201, the second substrate 202, and the barrier rib structure 214 can be divided into at least two or more discharge spaces, which will now be described in detail.

Referring to FIGS. 2 through 4, the barrier rib structure 214 includes first barrier portions 215 disposed in the X direction of the plasma display panel 200, and second barrier portions 216 disposed in the Y direction of the plasma display panel 200. The first barrier portions 215 extend in one unit from a pair of adjacently disposed second barrier portions 216 towards another second barrier portion 216. The discharge cells defined by the barrier rib structure 214 have a rectangular shape. The discharge cells are consecutively disposed along the X and Y directions of the plasma display panel 200.

The barrier rib structure 214 according to the present embodiment is not limited to the above, that is, it can have any structure that can define the discharge cells. Accordingly, a horizontal cross-section of the discharge cells can have various shapes such as circular, oval, or rectangular shape.

At this point, in the discharge cells, as shown in FIG. 3, one discharge space S can be divided into a first discharge space S₁ and a second discharge space S₂ by an auxiliary barrier rib 218. That is, the auxiliary barrier ribs 218 are disposed across the discharge space S to divided one discharge space S into a plurality of spaces. In the present embodiment, the auxiliary barrier ribs 218 extend in the same direction as the first barrier rib 215.

The auxiliary barrier ribs 218 extend from one second barrier rib 216 of the plasma display panel 200 towards another second barrier rib 216 across the discharge space S. Each of the auxiliary barrier ribs 218 is disposed across the center of the discharge space S, and the discharge space S is divided into a first discharge space S₁, and a second discharge space S₂ along the Y direction of the plasma display panel 200. In this manner, the auxiliary barrier ribs 218 are disposed along the X direction of the plasma display panel 200 to divide the discharge space S into multiple sub-discharge spaces S₁ and S₂.

The X electrodes 204 include the rectangular shaped X transparent electrodes 206 disposed in each of the discharge cells and the stripe shaped X bus electrodes 207 disposed in the X direction of the plasma display panel 200. The Y electrodes 205 include the rectangular shaped Y transparent electrodes 208 and the stripe shaped Y bus electrodes 209 disposed along the X direction of the plasma display panel 200.

The X bus electrodes 207 are disposed above every first barrier rib 215. The X bus electrodes 207 are disposed along the first barrier ribs 215 in a stripe shape.

The X transparent electrodes 206, which are electrically connected to the X bus electrodes 207, respectively, protrude in the discharge cells adjacent in the Y direction of the plasma display panel 200. That is, s FIGS. 3 and 4, each of the X transparent electrodes 206 include a first X transparent electrode 206a protruded in the discharge space S divided from one discharge cell and a second X transparent electrode 206b protruded in the discharge space S divided from another discharge cell adjacent to the one discharge cell in the Y direction of the plasma display panel 200.

In this way, since each of the X electrodes 204 includes the first X transparent electrode 206a and the second X transparent electrode 206b, which are disposed above the first barrier ribs 215 that define the discharge cells adjacent to each other and protrude towards different direction from both sides of the X bus electrode 207, the X electrodes 204 perform as common electrodes with regard to the discharge cells adjacent in the Y direction of the plasma display panel 200.

The Y bus electrodes 209 are formed on each of the auxiliary barrier ribs 218. The Y bus electrodes 209 are disposed along the auxiliary barrier ribs 218 in a stripe shape in the X direction of the plasma display panel 200, wherein each of the Y transparent electrodes 208 include a first Y transparent electrode 208a protruded in the discharge space S divided from one discharge cell and a second Y transparent electrode 208b protruded in the discharge space S divided from another discharge cell adjacent to the one discharge cell in the Y direction of the plasma display panel 200.

That is, as shown in FIGS. 3 and 4, the Y transparent electrodes 208 includes a first Y transparent electrode 208a protruded in the first discharge space S₁ which is divided from one discharge cell S and a second Y transparent electrode 208b protruded in the second discharge space S₂.

In this way, since the Y electrodes 205 include the first Y transparent electrodes 208a and the second Y transparent electrodes 208b, protrude from both sides of the Y bus electrodes 209, which are disposed above the auxiliary barrier ribs 218 that define one discharge cell into the first and second discharge spaces S₁ and S₂ and protrude in the divided first and second discharge spaces S₁ and S₂ from both sides of the Y bus electrodes 209, the Y electrodes 205 perform as electrodes for selecting discharge cells and sustaining discharge.

The address electrodes 212 are disposed in the Y direction of the plasma display panel 200 in a direction crossing the Y electrodes 205 in the X direction of the plasma display panel 200, and extend across the divided first and second discharge spaces S₁ and S₂.

Accordingly, the discharge electrodes included in the unit discharge cell are a plurality of X electrodes 204 disposed above the first barrier rib pair 215 that define the discharge cells in the Y direction of the plasma display panel 200, one Y electrode 205 that generates a sustain discharge together with the X electrodes 204 and is disposed above the auxiliary barrier rib 218 that divides one discharge cell S into multiple discharge spaces S₁ and S₂, and one address electrode 212 that generates address discharge together with the Y electrode 205 and extends across the divided first and second discharge spaces S₁ and S₂.

In this way, since one discharge space S is divided into a first discharge space S₁ and second discharge space S₂ by the auxiliary barrier rib 218, areas for coating the phosphor layers 217 are increased.

That is, the phosphor layers 217 are coated in both the first discharge space S₁ and the second discharge space S₂. More specifically, the phosphor layers 217 are coated on inner surfaces of the second dielectric layer 213, inner sides of the first barrier ribs 215, inner sides of the second barrier ribs 216, and both side surfaces of the auxiliary barrier ribs 218. Thus, the coating areas of the phosphor layers 217 are increased as much as the side surfaces of the auxiliary barrier ribs 218 due to the formation of the auxiliary barrier ribs 218.

An operation of the plasma display panel 200 having the above structure will now be described with reference to FIGS. 2 through 4.

When a predetermined pulse voltage is applied between the Y electrodes 205 and the address electrodes 212, discharge cells where light is to be emitted are selected. Wall charges are accumulated on inner walls of the selected discharge cells.

Next, a “+” voltage is applied to the X electrodes 204 and a voltage relatively higher than the “+” voltage is applied to the Y electrodes 205, the wall charges move due to a voltage difference between the X electrodes 204 and the Y electrodes 205.

Due to the movement of the wall charges, the wall charges collide with discharge gas atoms in the discharge cells to cause discharge. As a result of the discharge, plasma is generated, and the discharge expands from discharge gaps between the X transparent electrodes 206 and the Y transparent electrodes 208 where strong electric fields are formed towards edges of the discharge cells.

After discharge is generated as described above, the voltage difference between the X electrodes 204 and the Y electrodes 205 is reduced below a discharge voltage, a further discharge is not generated, but space charges and wall charges are accumulated in the discharge cells.

At this point, when the polarities of the voltages applied to the X electrodes 204 and the Y electrodes 205 are reversed, a discharge is re-generated with the aid of the wall charges. If the polarities of the X electrodes 204 and the Y electrodes 205 are reversed, the discharge process is repeated. In this manner, a discharge is stably generated by repeating the above process.

Meanwhile, ultraviolet rays generated due to the discharge excite the red, green, and blue phosphor layers 217 coated in each of the discharge cells. The excited phosphor layers 217 generate visible light which realizes a stationary or moving image by being emitted from the discharge cells.

At this point, in the unit discharge cell, the plurality of X electrodes 204 are disposed above the first barrier rib pair 215 disposed along the Y direction of the plasma display panel 200, and the Y electrodes 205 are disposed above the auxiliary barrier ribs 218 that define the discharge space S into the first discharge space S₁ and the second discharge space S₂. Therefore, discharge concentration portions are formed between the X transparent electrodes 206 and the Y transparent electrodes 208 in each of the divided first discharge space S₁ and the second discharge space S₂, thereby increasing light emission efficiency.

FIG. 5 is a cross-sectional view illustrating an assembled three-electrode alternating current surface discharge type plasma display panel 500 according to another embodiment of the present invention.

Referring to FIG. 5, the plasma display panel 500 includes a first substrate 501 and a second substrate 502 facing the first substrate 501. X electrodes 504 and Y electrodes 505 are disposed on an inner surface of the first substrate 501. The X electrodes 504 and Y electrodes 505 are buried in a first dielectric layer 510. A protective film layer 511 is formed on a surface of the first dielectric layer 510.

Address electrodes 512 are disposed in a direction crossing the Y electrodes 505 on an inner surface of the second substrate 502. The address electrodes 512 are buried in a second dielectric layer 513.

A barrier rib structure 514 that defines discharge cells together with the first and second substrates 501 and 502 is disposed between the first and second substrates 501 and 502. A discharge gas is filled in the discharge cells defined by the combination of the first substrate 501, the second substrate 502, and the barrier rib structure 514, and a phosphor layer 517 is formed in each of the discharge cells.

One discharge space S is divided into a first discharge space S₁ and a second discharge space S₂. That is, the discharge space S is divided into the first discharge space S₁ and the second discharge space S₂ by an auxiliary barrier rib 518 disposed across the center of the discharge space S.

At this point, the auxiliary barrier ribs 518 are separated from an inner surface of the protective film layer 511 unlike the barrier rib structure 514, and thus, form gaps 519 between upper surfaces thereof and an inner surface of the protective film layer 511. The gaps 519 form a step difference with the barrier rib structure 514 and is used as an impurity gas exhaust path when the discharge cells are vacuumed.

Also, due to the formation of the gaps 519, unlike the plasma display panel 200 of FIG. 4, the phosphor layers 517 are coated on the upper surfaces of the auxiliary barrier ribs 518 in addition to the inner surfaces of the second dielectric layer 513, the inner sides of the barrier rib structure 514, and the inner sides of the auxiliary barrier ribs 518, thereby increasing coating areas of the phosphor layers 517.

The X electrodes 504 include X transparent electrodes 506 and X bus electrodes 507 electrically connected to the X transparent electrodes 506. The Y electrodes 505 includes Y transparent electrodes 508 and Y bus electrodes 509 electrically connected to the Y transparent electrodes 508.

The X bus electrodes 507 are formed in a stripe shape on every barrier rib structure 514. The X bus electrodes 507 are disposed in regions corresponding to the barrier rib structure 514 that defines adjacent discharge cells. The X transparent electrodes 506 respectively protrude in the discharge space S of the unit discharge cell and discharge space S of another unit discharge cell adjacent thereto.

In this way, the X electrodes 504 are disposed above the barrier rib structure 514 that defines the discharge cells adjacent to each other, and the X transparent electrodes 506 connected to the X bus electrodes 507 respectively protrude in discharge spaces S of the discharge cells.

The Y bus electrodes 509 are formed in a stripe shape along the direction of the auxiliary barrier ribs 518. The Y transparent electrodes 508 respectively protrude in the divided first discharge space S₁ and the second discharge space S₂.

In this way, the Y bus electrodes 509 are disposed above the auxiliary barrier ribs 518 that define one discharge space S of the discharge cell into the first discharge space S₁ and the second discharge space S₂, and the Y transparent electrodes 508 respectively protrude in the first and second discharge spaces S₁ and S₂ divided by the auxiliary barrier ribs 518.

The address electrodes 512 are disposed in a direction crossing the Y electrodes 505, and extend across the first and second discharge spaces S₁ and S₂.

In this way, since one discharge space S of a unit discharge cell is divided into the first and second discharge spaces S₁ and S₂, discharge concentration portions are formed between the X electrodes 504 and the Y electrodes 505 in each of the first discharge space S₁ and the second discharge space S₂, thereby increasing light emission efficiency.

As described above, the plasma display panel according to the present invention has the following effects.

First, one discharge space is divided into a plurality of discharge spaces by forming an auxiliary barrier rib. Thus, coating areas of phosphor layers coated in a discharge cell are increased.

Second, one discharge space is divided into a plurality of discharge spaces and discharge electrodes that perform as common electrodes for generating a discharge in discharge cells adjacent to each other are formed on a barrier rib structure that defines the discharge cells. Therefore, a plurality of electric field concentration portions are formed between the X electrodes 504 and the Y electrodes 505 in the divided discharge spaces, thereby increasing light emission efficiency.

Third, since the Y electrodes are disposed above the auxiliary barrier ribs formed in the center of the discharge cells, the address electrodes can generate a further stabilized address discharge.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel comprising:
a plurality of substrates facing each other;
a plurality of discharge electrodes disposed between the substrates;
a barrier rib structure disposed between the substrates to define a plurality of discharge cells; and
a plurality of phosphor layers coated in the discharge cells,
wherein one discharge space of each of the discharge cells is divided into at least two discharge spaces.

2. The plasma display panel of claim 1, wherein the divided discharge spaces of each of the discharge cells are defined by an auxiliary barrier rib disposed in the discharge cell.

3. The plasma display panel of claim 2, wherein the auxiliary barrier rib extends from an inner wall of the barrier rib structure towards another inner wall of the barrier rib structure to divide one discharge cell into multiple discharge spaces.

4. The plasma display panel of claim 3, wherein the auxiliary barrier rib extends across the center region of each of the discharge cells.

5. The plasma display panel of claim 2, wherein the discharge electrodes comprise sustain discharge electrode pairs having X electrodes and Y electrodes and address electrodes disposed in a direction crossing the sustain discharge electrodes,
wherein the X electrodes are disposed above the barrier rib structure that defines adjacent discharge cells.

6. The plasma display panel of claim 5, wherein the X electrodes comprise X transparent electrodes and X bus electrodes electrically connected to the X transparent electrodes, and
the X bus electrodes are disposed above the barrier rib structure, the X transparent electrodes are connected to the X bus electrodes and respectively protrude in the discharge cells adjacent to each other.

7. The plasma display panel of claim 5, wherein the Y electrodes are disposed above the auxiliary barrier ribs.

8. The plasma display panel of claim 7, wherein the Y electrodes comprise Y transparent electrodes and Y bus electrodes electrically connected to the Y transparent electrodes, and
the Y bus electrodes are disposed above the auxiliary barrier ribs, and the Y transparent electrodes are connected to the Y bus electrodes and respectively protrude in the divided discharge spaces of the discharge cells.

9. The plasma display panel of claim 5, wherein the address electrodes extend in a direction crossing the Y electrodes across the divided discharge spaces of the discharge cells.

10. The plasma display panel of claim 5, wherein one discharge space comprises the plurality of X electrodes disposed above the barrier rib pair, one Y electrode disposed above the auxiliary barrier rib, and one address electrode.

11. The plasma display panel of claim 1, wherein the barrier rib comprises first barrier ribs disposed in a direction of the substrate and second barrier ribs which are disposed in another direction of the substrate and are connected in one unit with the first barrier ribs to define a plurality of discharge spaces.

12. The plasma display panel of claim 11, wherein the discharge spaces defined by the barrier rib structure have a rectangular shaped horizontal cross-section.

13. The plasma display panel of claim 11, wherein the auxiliary barrier ribs extend in a direction parallel to the first barrier ribs across the discharge spaces.

14. The plasma display panel of claim 11, wherein the auxiliary barrier rib extends from a pair of adjacently disposed second barrier ribs towards each other to divide one discharge cell into multiple discharge spaces.

15. The plasma display panel of claim 11, wherein the discharge electrodes that commonly relate to discharge in the discharge cells adjacent to each other are disposed above the first barrier ribs, and discharge electrode that relate to discharge in the divided discharge spaces are disposed above the auxiliary barrier ribs.

16. The plasma display panel of claim 2, wherein the phosphor layers are coated in each of the divided discharge spaces.

17. The plasma display panel of claim 16, wherein the phosphor layers are coated on side walls of the barrier rib structure, side walls of the auxiliary barrier ribs, and on the substrate.

18. The plasma display panel of claim 2, wherein gaps are formed between upper surfaces of the auxiliary barrier ribs and an inner surface of the substrate to exhaust a discharge gas when the discharge spaces are vacuumed.

19. The plasma display panel of claim 18, wherein the phosphor layers are further formed on the upper surfaces of the auxiliary barrier ribs.

20. A plasma display panel comprising:
a first substrate and a second substrate facing each other;
a plurality of discharge electrodes disposed on an inner surface of the first substrate;
a barrier rib structure disposed between the first and second substrates to define a plurality of discharge cells;
a plurality of auxiliary ribs, wherein each discharge cell is divided into at least two discharge spaces by a corresponding one of said auxiliary ribs; and
a plurality of phosphor layers coating exposed surfaces of said barrier rib surfaces, said auxiliary ribs and said second substrate in the discharge cells.
